(19) United States
(12) Patent Application Publication
(10) Pub. No.: US 2011/0065356 A1
(43) Pub. Date: Mar. 17, 2011

(54) KEYSTONE GAME CALL

(76) Inventor: Daniel Blodgett, Corning, NY (US)

(21) Appl. No.: 12/857,314

(22) Filed: Aug. 16, 2010

Related U.S. Application Data
(60) Provisional application No. 61/233,927, filed on Aug. 14, 2009.

(51) Int. Cl. A01M 31/00

(52) U.S. Cl. 446/397

(57) ABSTRACT

a keystone game call capable of producing various tones to reproduce the sounds of game such as fowl and more particularly wild turkeys.

### CROSS-REFERENCE TO RELATED APPLICATIONS

This application claims priority from U.S. Provisional Patent Application Ser. No. 61/233,927, filed Aug. 14, 2010, the contents of which are incorporated by reference in their entirety.

### FIELD OF THE INVENTION

This invention relates to a game call apparatus, and more particularly to friction-type turkey call capable or reproducing various sounds of wild turkeys.

### BACKGROUND OF THE INVENTION

Wild turkeys are known to produce various sounds such as gobbles, clucks, putts, purrs, yelps, cutis, cackles, kee-kees and the like. To call a turkey, hunters competitive callers, bird watchers or photographers typically utilize devices to reproduce the natural sounds of wild turkeys. One type of turkey call is a friction call. Friction calls are the most common type of turkey call available because they are easy to use and produce realisitic turkey sounds. Generally, friction calls are made from a rough round surface. Sound is generated by draging a striker acrous the rough surface.

Referring to FIG. 1, there is shown a friction call according to the prior art. The friction call 10 contains a housing 11 and a rough striking surface 12 attached thereto. To create sound a striker 13 is rubbed against the rough striking surface 12. Generally, the housing 11 has holes on the side opposite the striking surface 12 to allow sound to radiate from the friction call.

Generally, friction calls are only capable of producing a single tone. No matter how the friction call is held, or where on the striking surface the striker is used, a single tone representative of a turkey sound is produced. However, it is unknown what type of sound a wild turkey will respond to on any given day. For this reason, it is common for hunter to carry multiple turkey calls to produce distinct sounds in attempt to call wild turkeys.

Therefore, a friction call that can produce a wide range of tones is desired.

Further, a friction call that fits easily in the users hand is desired.

### SUMMARY OF THE INVENTION

The invention comprises, in one form thereof, a keystone game call capable of producing various tones to reproduce the sounds of game such as fowl and more particularly wild turkeys.

More particularly, the invention includes a unique shape to assist in the reproduction of various tones similar to those of wild turkeys.

An advantage of the present invention is that the a single apparatus is capable of producing various tones representative of wild turkey sounds.

A further advantage of the present invention is that the keystone turkey call fits comfortable in the palm of a hand.

### BRIEF DESCRIPTION OF THE DRAWINGS

The present invention is disclosed with reference to the accompanying drawings, wherein:

FIG. 1 is a representative view of a conventional friction call according to the prior art;

FIG. 2A is a top view of one embodiment of a keystone game call;

FIG. 2B is a front view of the keystone game call shown in FIG. 2A;

FIG. 2C is a back view of the keystone game call shown in FIG. 2A;

FIG. 3A is a top view of a another embodiment of a keystone game call;

FIG. 3B is a front view of the keystone game call shown in FIG. 3A;

FIG. 3C is a back view of the keystone game call shown in FIG. 3A;

FIG. 4 is a view of a keystone game call having finger grips on both sides;

FIG. 5A is a view of a keystone game call having a v-grip slot; and

FIG. 5B is a side view of the keystone game call shown in FIG. 5A exemplifying the v-grip.

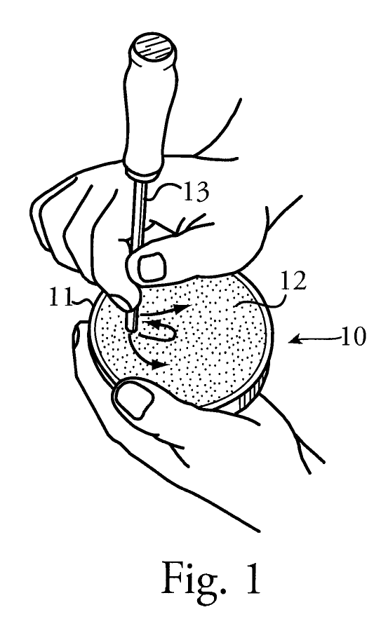

Corresponding reference characters indicate corresponding parts throughout the several views. The examples set out herein illustrate several embodiments of the invention but should not be construed as limiting the scope of the invention in any manner.

### DETAILED DESCRIPTION

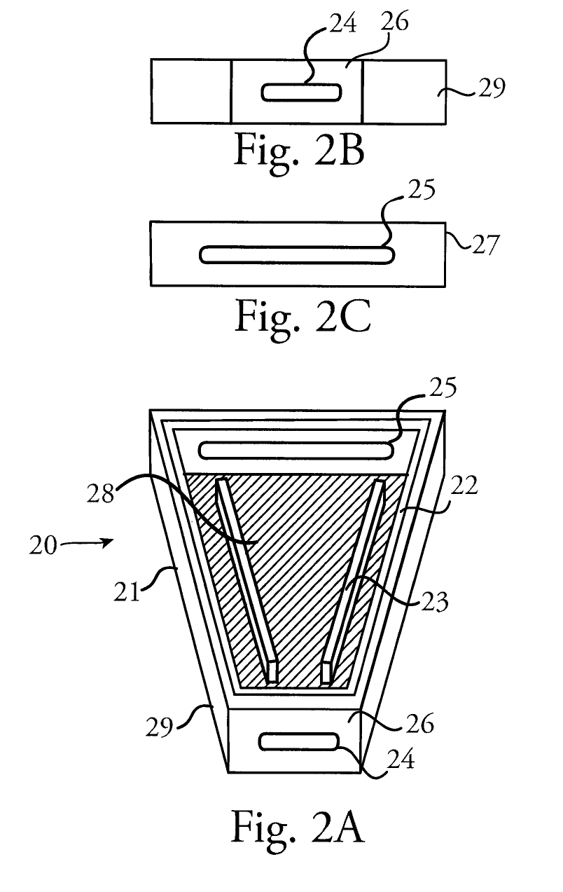

Referring to FIGS. 2A through 2C, there is shown one embodiment of the keystone game call. The keystone game call 20 includes a housing 21, a first face 26 having an optional opening 24 and a second face 27 having an opening 25.

In use, the keystone game call 20 has a striking surface (not shown) to rub a striker against to produce sound. By utilizing a tapered shape depending on where the striker is rubbed against the striking surface distinct tones can be produced. Optionally, the keystone game call 20 has one or more openings to produce sound. By utilizing different sized openings and holding the keystone game call 20 in a different position various tones can be produced.

The housing 21 is generally trapezoidal. In one embodiment the housing has two sides having openings to direct sound. It is understood that the housing may have openings on just one side, three sides or all four sides. Optionally, openings may be placed in the bottom surface 28. In one embodiment, the housing has two sides 29 having no openings and a short front face 26 having a first opening 24 and a second long face 27 having an opening 25. It is understood that the two sides 29 may be of equal or different lengths. In one embodiment, at least one of the sides 29 is between 2 and 8 inches in length. In another embodiment, at least one of the sides 29 is less than 5 inches in length. In yet another embodiment, at least one of the sides 29 is about 4 inches in length. In another embodiment, at least one of the sides 29 is about 3.5 inches in length. In one embodiment, the length of the long face 27 and the length of at least one of the side faces 29 are within 1 inch of each other. In yet another embodiment, the length of the long face 27 and the length of at least one of the side faces 29 are within 0.5 inches of each other.

The two sides 29 may form the same or different angles with the short front face 26. In one embodiment, the angle between the short front face 26 and the side 29 is between 91 and 140 degrees. In another embodiment, the angle between the short front face 26 and the side 29 is between 100 and 110 degrees. In yet another embodiment, the angle between the short front face 26 and the side 29 is about 105 degrees.

In one embodiment, the housing 21 further contains an ergonomically shaped grip on one or both of the sides 29. The ergonomically shaped grip can be custom formed as part of the housing 21. In another embodiment, the ergonomically shaped grip is added onto the housing and may be a fixed grip or removable for user preference.

The housing 21 may be made out of any material suitable for creating a game call. For example, wood, resin, plastic, polymer or metal may be used to form the housing 21.

To form a sound chamber, the housing 21 optionally contains a recessed area 22 for holding the striking surface. In one embodiment, the recessed area 22 provides support for the striking surface. In another embodiment, the housing 21 optional contains internal supports 23 provide support for the striking surface. In yet another embodiment, both the recessed area 22 and the internal supports 23 provide support for the striking surface. It is understood that the striking surface may contain multiple layers of material to enhance sound reproduction. The striking surface may be any suitable material such as, slate, glass or aluminum.

The internal supports 23, if present, may be made from any suitable material. In one embodiment, the internal supports 23 are made from the same material as the housing 21. The internal supports 23 may be of any shape size or thickness. The internal supports 23 may support the striking surface or any intermediate sound enhancing or support layer. For example, an inside soundboard may be used to enhance sound reproduction. The soundboard may be of any suitable material. In one embodiment the soundboard is glass. In one embodiment, the housing is filled with a sound enhancing material.

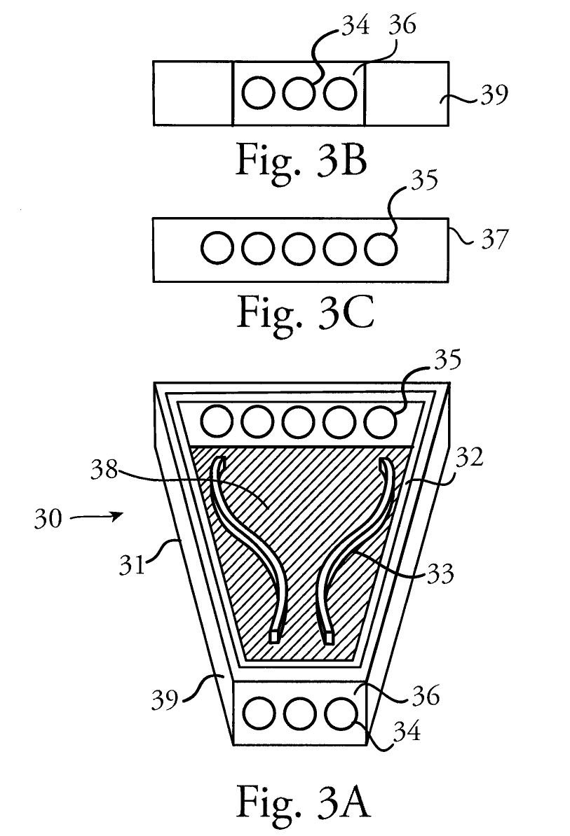

The openings in the housing may be of any size or shape. As shown in FIGS. 2A-2C the openings are shown as elliptical opening. FIGS. 3A-3C show an alternative embodiment of the keystone game call. As shown in FIGS. 3A-3C, the openings are shown as circular holes. It is understood that the openings can be of any shape or size.

Referring now to FIGS. 3A-3C there is shown an alternative embodiment of the keystone game call 30. The housing 31 contains an optional recessed area 32 and internal supports 33. It is understood that the internal supports can be of any size or shape and may also be utilized to enhance sound reproduction. The front face 36 and back face 37 contain a series of openings 34 and 35 respectively. The openings are designed to enhance sound reproduction and while shown as circular holes, it is understood that the opening can take any suitable shape.

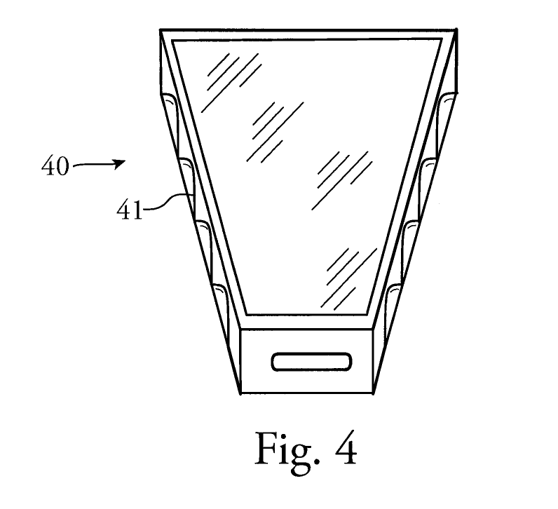

Referring to FIG. 4 there is shown an alternative embodiment of the keystone game call having finger grips 41 on both sides. It is understood that the finger grips may be positioned on only one side of the keystone call. The finger grips may also be coated or covered with a material to provide improved grip or additional softness.

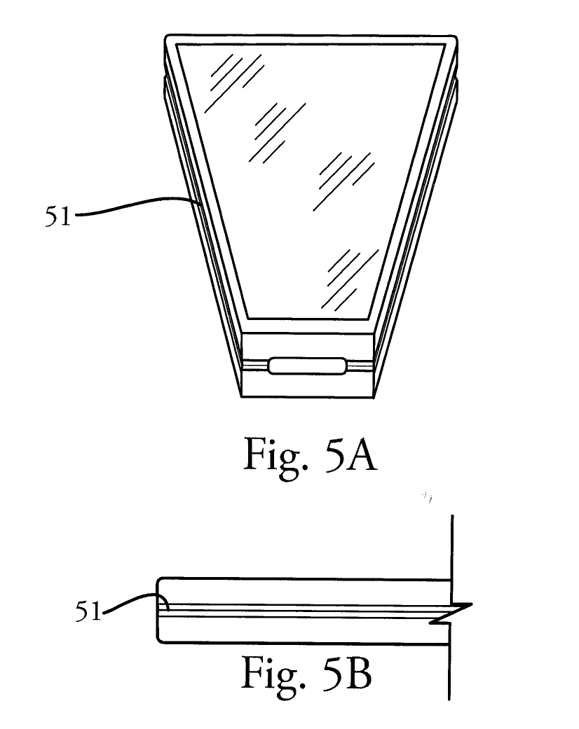

Referring to FIGS. 5A-5B there is shown an alternative embodiment of the keystone game call having a grip slot 51 along the sides of the keystone game call. The grip slot 51 can be “v,” “u,” or any other shape to increase grip on the keystone game call. In one embodiment the grip slot provides an additional striking surface. This additional striking surface provides a further range of tones to assist in calling game.

While the invention has been described with reference to particular embodiments, it will be understood by those skilled in the art that various changes may be made and equivalents may be substituted for elements thereof without departing from the scope of the invention. In addition, many modifications may be made to adapt a particular situation or material to the teachings of the invention without departing from the scope of the invention.

Therefore, it is intended that the invention not be limited to the particular embodiments disclosed as the best mode contemplated for carrying out this invention, but that the invention will include all embodiments falling within the scope and spirit of the appended claims.

1. A keystone game call comprising,
a housing having:
a bottom surface,
a first face, and
a second face on the opposite side of said first face, said second face having at least one opening, said second face having a length that is greater than a length of said first face; and
a striking surface in a plane parallel to said bottom surface.

2. The keystone game call of claim 1, wherein said first face has at least one opening.

3. The keystone game call of claim 1, wherein said second face has a plurality of openings.

4. The keystone game call of claim 1, wherein said housing is substantially trapezoidal in shape.

5. The keystone game call of claim 1, further comprising two sides of equal length connecting said first face to said second face.

6. The keystone game call of claim 5, wherein the angles between said two sides of equal length and said first face is an obtuse angle.

7. The keystone game call of claim 6, wherein the angles between said two sides of equal length and said second face is an acute angle.

8. The keystone game call of claim 5, wherein at least one of said two sides of equal length has at least one opening.

9. The keystone game call of claim 1, further comprising at least one support internal support affixed to said bottom surface.

10. The keystone game call of claim 5, further comprising a removable casing covering at least a portion of said two sides of equal length

11. The keystone game call of claim 5, wherein at least one of said two sides of equal length has a series of grooves fashion to fit a human hand.

12. The keystone game call of claim 1, further comprising a soundboard positioned under said striking surface.

13. The keystone game call of claim 1, wherein said at least opening in said second face is a single elliptical opening.

14. The keystone game call of claim 1, wherein said at least one opening in said second face is a plurality of circular openings.

15. The keystone game call of claim 5, further comprising a grip slot along at least one said two sides of equal length.

16. A keystone game call comprising:
a bottom surface;
a striking surface;
a first side having a first end a second end and at least one opening;
a second having a first and second end, said second side being opposite said first side;
a third side connecting said first end of said first side to said first end if said second side; and
a fourth side connecting said second end of said first side to said second end of said second side.

17. The keystone game call of claim 16, wherein the distance from said first end to said second end of said first side is greater than the distance from said first end to said second end of said second side

18. The keystone game call of claim 16, wherein said first side, said second side, said third side and said fourth side form a generally trapezoidal shape.

19. The keystone game call of claim 16, further comprising a recessed lip along an upper surface of the sides to house said striking surface.

20. A method for manufacturing a keystone game call comprising the steps of:
providing a housing having:
a bottom surface,
a first face, and
a second face on the opposite side of said first face, said second face having at least one opening, said first face having a length that is less than a length of said second face;
attaching a striking surface in a plane parallel to said bottom surface.
